(19) United States
(12) Patent Application Publication
(10) Pub. No.: US 2017/0287472 A1
(43) Pub. Date: Oct. 5, 2017

(54) SPEECH RECOGNITION APPARATUS AND SPEECH RECOGNITION METHOD

(71) Applicant: MITSUBISHI ELECTRIC CORPORATION, Tokyo (JP)

(72) Inventors: Isamu OGAWA, Tokyo (JP); Toshiyuki HANAZAWA, Tokyo (JP)

(73) Assignee: MITSUBISHI ELECTRIC CORPORATION, Tokyo (JP)

(21) Appl. No.: 15/507,695

(22) PCT Filed: Dec. 18, 2014
(86) PCT No.: PCT/JP2014/083575

§ 371 Date: Feb. 28, 2017

(51) Int. Cl. G10L 15/18; G06F 3/041; G10L 15/25

(52) U.S. Cl. CPC G10L 15/18; G10L 15/25; G06F 3/041

(57) ABSTRACT

An apparatus includes a lip image recognition unit 103 to recognize a user state from image data which is information other than speech; a non-speech section deciding unit 104 to decide from the recognized user state whether the user is talking; a speech section detection threshold learning unit 106 to set a first speech section detection threshold (SSDT) from speech data when decided not talking, and a second SSDT from the speech data after conversion by a speech input unit when decided talking; a speech section detecting unit 107 to detect a speech section indicating talking from the speech data using the thresholds set, wherein if it cannot detect the speech section using the second SSDT, it detects the speech section using the first SSDT; and a speech recognition unit 108 to recognize speech data in the speech section detected, and to output a recognition result.

### TECHNICAL FIELD

The present invention relates to a speech recognition apparatus and a speech recognition method for extracting a speech section from input speech and for carrying out speech recognition of the speech section extracted.

### BACKGROUND ART

Recently, a speech recognition apparatus for receiving speech as an operation input has been mounted on a mobile terminal or navigation system. A speech signal inputted to the speech recognition apparatus includes not only speech a user utters who gives the operation input, but also sounds other than target sound like external noise. For this reason, a technique is required that appropriately extracts a section the user utters (hereinafter referred to as “speech section”) from the speech signal inputted in a noisy environment and carries out speech recognition, and a variety of techniques have been disclosed.

For example, a Patent Document 1 discloses a speech section detection apparatus that extracts acoustic features for detecting a speech section from a speech signal, extracts image features for detecting the speech section from image frames, generates acoustic image features by combining the acoustic features with the image features extracted, and decides the speech section on the basis of the acoustic image features.

In addition, a Patent Document 2 discloses a speech input apparatus configured in such a manner as to specify the position of a talker by deciding the presence or absence of speech on the analysis of mouth images of a speech input talker, decide that the movement of the mouth at the position located is the source of a target sound, and exclude the movement from a noise decision.

In addition, a Patent Document 3 discloses a digit string speech recognition apparatus which successively alters a threshold for cutting out a speech section from input speech in accordance with the value of a variable i (i=5, for example), obtains a plurality of recognition candidates by cutting out the speech sections in accordance with the thresholds altered, and determines a final recognition result by totalizing recognition scores calculated from the plurality of recognition candidates obtained.

### CITATION LIST

### Patent Literature

### [Patent Document]

Patent Document 1: Japanese Patent Laid-Open No. 2011-59186.
Patent Document 2: Japanese Patent Laid-Open No. 2006-39267.
Patent Document 3: Japanese Patent Laid-Open No. H8-314495/1996.

### SUMMARY OF INVENTION

### Technical Problem

However, as for the techniques disclosed in the foregoing Patent Document 1 and Patent Document 2, it is necessary to always capture videos with a capturing unit in parallel with the speech section detection and speech recognition processing for the input speech, and to decide the presence or absence of speech from the analysis of the mouth images, which leads to a problem of an increase in the amount of computation.

In addition, the technique disclosed in the foregoing Patent Document 3 has to execute speech section detection processing and speech recognition processing five times while changing the thresholds for a single utterance of the user, which leads to a problem of an increase in the amount of computation.

Furthermore, there is a problem of an increase in delay time until obtaining a speech recognition result in a case in which the speech recognition apparatus with the large amount of computation is operated on the hardware with a low processing performance, such as a tablet PC. In addition, reducing the amount of computation of image recognition processing or speech recognition processing in conformity with the processing performance of the tablet PC or the like leads to a problem of the degradation of recognition processing performance.

The present invention is implemented to solve the foregoing problems. Therefore it is an object of the present invention to provide a speech recognition apparatus and speech recognition method capable of reducing a delay time until obtaining a speech recognition result and of preventing the degradation of recognition processing performance even when the speech recognition apparatus is used on hardware with a low processing performance.

### Solution to Problem

A speech recognition apparatus in accordance with the present invention comprises: a speech input unit configured to acquire collected speech and to convert the speech to speech data; a non-speech information input unit configured to acquire information other than the speech; a non-speech operation recognition unit configured to recognize a user state from the information other than the speech the non-speech information input unit acquires; a non-speech section deciding unit configured to decide whether the user is talking or not from the user state the non-speech operation recognition unit recognizes; a threshold learning unit configured to set a first threshold from the speech data converted by the speech input unit when the non-speech section deciding unit decides that the user is not talking, and to set a second threshold from the speech data converted by the speech input unit when the non-speech section deciding unit decides that the user is talking; a speech section detecting unit configured to detect, using the threshold set by the threshold learning unit, a speech section indicating that the user is talking from the speech data converted by the speech input unit; and a speech recognition unit configured to recognize speech data in the speech section detected by the speech section detecting unit, and to output a recognition result, wherein the speech section detecting unit detects the speech section by using the first threshold, if the speech section detecting unit cannot detect the speech section by using the second threshold.

### Advantageous Effects of Invention

According to the present invention, even when hardware with a low processing performance is used, it can reduce the delay time until it obtains the speech recognition result, and prevent the degradation of the recognition processing performance.

### BRIEF DESCRIPTION OF DRAWINGS

FIG. 1 is a block diagram showing a configuration of a speech recognition apparatus of an embodiment 1;

FIG. 2 is a diagram illustrating processing, a speech input level and a CPU load of the speech recognition apparatus of the embodiment 1;

FIG. 3 is a flowchart showing the operation of the speech recognition apparatus of the embodiment 1;

FIG. 4 is a block diagram showing a configuration of a speech recognition apparatus of an embodiment 2;

FIG. 5 is a table showing an example of an operation scenario stored in an operation scenario storage of the speech recognition apparatus of the embodiment 2;

FIG. 6 is a diagram illustrating processing, a speech input level and a CPU load of the speech recognition apparatus of the embodiment 2;

FIG. 7 is a flowchart showing the operation of the speech recognition apparatus of the embodiment 2;

FIG. 8 is a block diagram showing a configuration of a speech recognition apparatus of an embodiment 3;

FIG. 9 is a diagram illustrating processing, a speech input level and a CPU load of the speech recognition apparatus of the embodiment 3;

FIG. 10 is a flowchart showing the operation of the speech recognition apparatus of the embodiment 3;

FIG. 11 is a block diagram showing a hardware configuration of a mobile terminal equipped with a speech recognition apparatus in accordance with the present invention.

### DESCRIPTION OF EMBODIMENTS

The best mode for carrying out the invention will now be described with reference to the accompanying drawings to explain the present invention in more detail.

### Embodiment 1

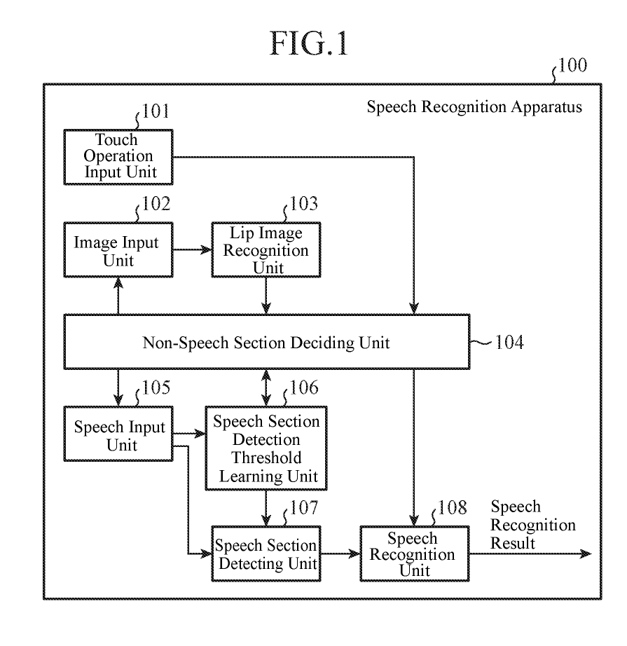

FIG. 1 is a block diagram showing a configuration of a speech recognition apparatus 100 of an embodiment 1.

The speech recognition apparatus 100 is comprised of a touch operation input unit (non-speech information input unit) 101, an image input unit (non-speech information input unit) 102, a lip image recognition unit (non-speech operation recognition unit) 103, a non-speech section deciding unit 104, a speech input unit 105, a speech section detection threshold learning unit 106, a speech section detecting unit 107, and a speech recognition unit 108.

Incidentally, although the following description will be made by way of example in which a user carries out a touch operation via a touch screen (not shown), the speech recognition apparatus 100 is also applicable to a case in which an input means other than a touch screen is used, or a case in which an input means with an input method other than a touch operation is used.

The touch operation input unit 101 detects a touch of a user onto a touch screen and acquires the coordinate values of the touch detected on the touch screen. The image input unit 102 acquires videos taken with a capturing means like a camera and converts the videos to image data. The lip image recognition unit 103 carries out analysis of the image data the image input unit 102 acquires, and recognizes movement of the user's lips. The non-speech section deciding unit 104 decides whether the user is talking or not by referring to a recognition result of the lip image recognition unit 103 when the coordinate values acquired by the touch operation input unit 101 are within a region for performing a non-speech operation. If it decides that the user is not talking, the non-speech section deciding unit 104 instructs the speech section detection threshold learning unit 106 to learn a threshold used for detecting a speech section. A region for performing an operation for speech, which is used for the non-speech section deciding unit 104 to make a decision, means a region on the touch screen where a speech input reception button and the like are arranged, and a region for performing the non-speech operation means a region where a button for making a transition to a lower level screen and the like are arranged.

The speech input unit 105 acquires the speech collected by a collecting means such as a microphone and converts the speech to speech data. The speech section detection threshold learning unit 106 sets a threshold for detecting an utterance of a user from the speech the speech input unit 105 acquires. The speech section detecting unit 107 detects the utterance of the user from the speech the speech input unit 105 acquires in accordance with the threshold the speech section detection threshold learning unit 106 sets. When the speech section detecting unit 107 detects the utterance of the user, the speech recognition unit 108 recognizes the speech the speech input unit 105 acquires and outputs a text which is a speech recognition result.

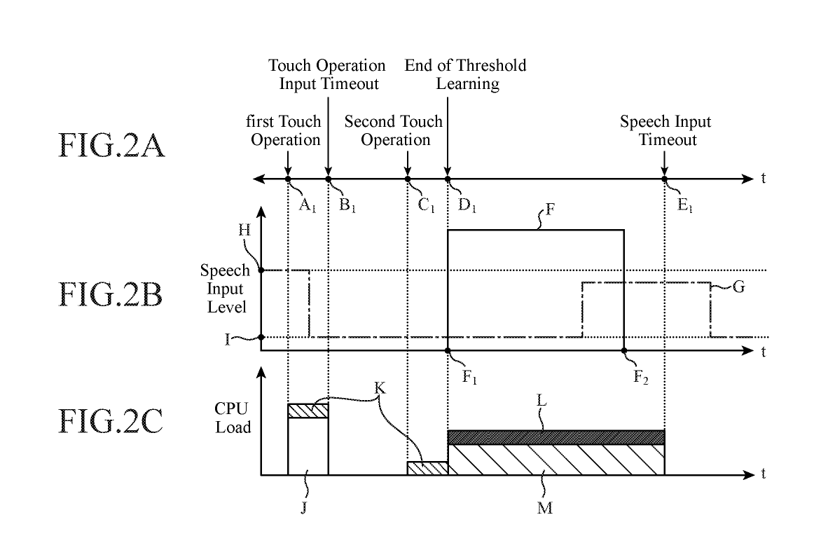

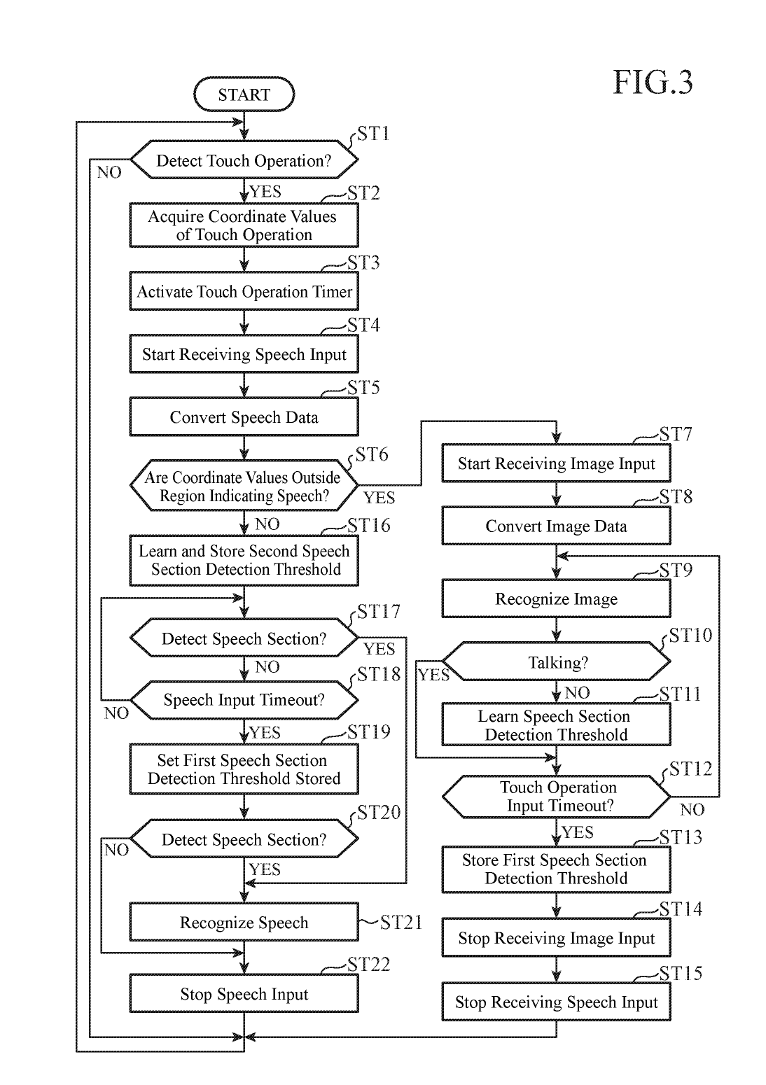

Next, referring to FIG. 2 and FIG. 3, the operation of the speech recognition apparatus 100 of the embodiment 1 will be described. FIG. 2 is a diagram illustrating an example of the input operation of the speech recognition apparatus 100 of the embodiment 1, and FIG. 3 is a flowchart showing the operation of the speech recognition apparatus 100 of the embodiment 1.

First, FIG. 2A shows on the time axis, time A₁ at which the user carries out a first touch operation, time B₁ indicating an input timeout of the touch operation, time C₁ at which the user carries out a second touch operation, time D₁ indicating the end of the threshold learning, and time E₁ indicating a speech input timeout.

FIG. 2B shows a time variation of the input level of the speech supplied to the speech input unit 105. A solid line indicates speech production F (F₁ is the initial position of the speech production, and F₂ is the final position of the speech production), and a dash-dotted line shows noise G. Incidentally, a value H shown on the axis of the speech input level designates a first speech section detection threshold, and a value I designates a second speech section detection threshold.

FIG. 2C shows a time variation of the CPU load of the speech recognition apparatus 100. A region J designates a load of, and a region K designates a load of threshold learning processing, and a region L designates a load of speech section detection processing, and a region M designates a load of speech recognition processing.

In a state in which the speech recognition apparatus 100 is operating, the touch operation input unit 101 makes a decision as to whether or not a touch operation onto the touch screen is detected (step ST1). If a user pushes down a part of the touch screen with his/her finger while making the decision, the touch operation input unit 101 detects the touch operation (YES at step ST1), acquires the coordinate values of touch detected in the touch operation, and outputs the coordinate values to the non-speech section deciding unit 104 (step ST2). Acquiring the coordinate values outputted at step ST2, the non-speech section deciding unit 104 activates a built-in timer and starts measuring a time elapsed from the time of detecting the touch operation (step ST3).

For example, when the touch operation input unit 101 detects the first touch operation (time) shown in FIG. 2A at step ST1, it acquires the coordinate values of touch detected in the first touch operation at step ST2, and the non-speech section deciding unit 104 measures a time elapsed from detecting the first touch operation at step ST3. The elapsed time measured is used for deciding the elapse of the input timeout (time B₁) of the touch operation of FIG. 2A.

The non-speech section deciding unit 104 instructs the speech input unit 105 to start the speech input, and the speech input unit 105 starts the input reception of the speech in response to the instruction (step ST4), and converts the speech acquired to the speech data (step ST5). The speech data after the conversion consists of, for example, PCM (Pulse Code Modulation) data resulting from the digitization of the speech signal the speech input unit 105 acquires.

In addition, the non-speech section deciding unit 104 decides whether the coordinate values outputted at step ST2 are outside a prescribed region indicating an utterance (step ST6). If the coordinate values are outside the region indicating the utterance (YES at step ST6), the non-speech section deciding unit 104 decides that the operation is a non-speech operation without accompanying an utterance, and instructs the image input unit 102 to start the image input. In response to the instruction, the image input unit 102 starts reception of video input (step ST7), and converts the video acquired to a data signal such as video data (step ST8). Here, the video data consists of, for example, image frames obtained by digitizing the image signal the image input unit 102 acquires and by converting the digitized image signal to a series of continuous still images. The description below will be made using an example of image frames.

The lip image recognition unit 103 carries out image recognition of the movement of the user's lips from the image frames converted at step ST8 (step ST9). The lip image recognition unit 103 decides whether the user is talking or not from the image recognition result recognized at step ST9 (step ST10). As concrete processing at step ST10, for example, the lip image recognition unit 103 extracts lip images from the image frames, calculates the shape of the lips from the width and height of the lips by a publicly known technique, followed by deciding whether or not the user utters on the basis of whether or not the change of the lip shape agrees with a preset lip shape pattern at the utterance. If the change of the lip shape agrees with the lip shape pattern, the lip image recognition unit 103 decides that the user is talking.

When the lip image recognition unit 103 decides that the user is talking (YES at step ST10), it proceeds to the processing at step ST12. On the other hand, if the lip image recognition unit 103 decides that the user is not talking (NO at step ST10), the non-speech section deciding unit 104 instructs the speech section detection threshold learning unit 106 to learn the threshold of the speech section detection. In response to the instruction, the speech section detection threshold learning unit 106 records a value of the highest speech input level within a prescribed period of time from the speech data inputted from the speech input unit 105, for example (step ST11).

Furthermore, the non-speech section deciding unit 104 decides whether or not a timer value measured by the timer activated at step ST3 reaches a preset timeout threshold, that is, whether or not the timer value reaches the timeout of the touch operation input (step ST12). More specifically, the non-speech section deciding unit 104 decides whether the timer value reaches the time B₁ of FIG. 2 or not. Unless the timer value reaches the timeout of the touch operation input (NO at step ST12), the processing is returned to step ST9 to repeat the foregoing processing. In contrast, if the timer value reaches the timeout of the touch operation input (YES at step ST12), the non-speech section deciding unit 104 causes the speech section detection threshold learning unit 106 to store the value of the speech input level recorded at step ST11 in a storage area (not shown) as the first speech section detection threshold (step ST13). In the example of FIG. 2, it stores the value of the highest speech input level in the speech data input from the time A₁, at which the first touch operation is detected, to the time B₁ which is the touch operation input timeout, that is, the value H of FIG. 2B, as the first speech section detection threshold.

Next, the non-speech section deciding unit 104 instructs the image input unit 102 to stop the reception of the image input (step ST14), and the speech input unit 105 to stop the reception of the speech input (step ST15). After that, the flow chart returns to the processing at step ST1 to repeat the foregoing processing.

During the foregoing processing from step ST7 to step ST15, only the speech section detection threshold learning processing is performed while image recognition processing is executed (see the region J (image recognition processing) and region K (speech section detection threshold learning processing) from the time A₁ to the time B₁ of FIG. 2C).

On the other hand, if the coordinate values are within the region indicating the utterance in the decision processing at step ST6 (NO at step ST6), the non-speech section deciding unit 104 decides that it is an operation accompanying an utterance, and instructs the speech section detection threshold learning unit 106 to learn the threshold of the speech section detection. In response to the instruction, the speech section detection threshold learning unit 106 learns, for example, the value of the highest speech input level within a prescribed period of time from the speech data inputted from the speech input unit 105 and stores the value as the second speech section detection threshold (step ST16).

In the example of FIG. 2, it learns the value of the highest speech input level in the speech data input from the time C₁, at which the second touch operation is detected, to the time D₁ at which the threshold learning ends, that is, the value I of FIG. 2B, and stores the value I as the second speech section detection threshold. Incidentally, it is assumed that the user is not talking during the learning of the second speech section detection threshold.

Next, according to the second speech section detection threshold stored at step ST16, the speech section detecting unit 107 decides whether it can detect the speech section from the speech data inputted via the speech input unit 105 after the completion of the speech section detection threshold learning at step ST16 (step ST17). In the example of FIG. 2, it detects the speech section in accordance with the value I which is the second speech section detection threshold. More specifically, it decides a point as the initial position of the speech, the point at which the speech input level of the speech data inputted after the time D₁, at which the threshold learning ends, exceeds the second speech section detection threshold I, and decides that a point as the final position of the speech, the point at which the speech input level falls below the value I, which is the second speech section detection threshold, in the speech data following the initial position of the speech.

If the speech data does not include any noise, it is possible to detect the initial position F₁ and the final position F₂ as shown by the speech production F of FIG. 2, and in the decision processing at step ST17, it is determined that the speech section can be detected (YES at step ST17). If the speech section can be detected (YES at step ST17), the speech section detecting unit 107 inputs the speech section it detects to the speech recognition unit 108, and the speech recognition unit 108 carries out the speech recognition and outputs the text of the speech recognition result (step ST21). After that, the speech input unit 105 stops the reception of the speech input in response to the instruction to stop the reception of the speech input sent from the non-speech section deciding unit 104 (step ST22), and returns to the processing at step ST1.

On the other hand, if noise occurs in the speech data, for example, as represented by the noise G superimposed on the speech production F of FIG. 2, the initial position F₁ of the speech production F is correctly detected because the initial position F₁ is higher than the value I which is the second speech section detection threshold, but the final position F₂ of the speech production F is not correctly detected because the noise G is superimposed upon the final position F₂, and the final position F₂ remains higher than the value I of the second speech section detection threshold. Thus, in the decision processing at step ST17, the speech section detecting unit 107 decides that the speech section cannot be detected (NO at step ST17). If it cannot detect the speech section (NO at step ST17), the speech section detecting unit 107 refers to a preset speech input timeout value and decides whether it reaches the speech input timeout or not (step ST18). The detailed processing at step ST18 will be described below. The speech section detecting unit 107 continues counting time from a time point when the speech section detecting unit 107 detects the initial position F₁ of the speech production F, and decides whether or not a count value reaches the time E₁ of the preset speech input timeout.

Unless it reaches the speech input timeout (NO at step ST18), the speech section detecting unit 107 returns to the processing at step ST17 and continues the detection of the speech section. On the other hand, if it reaches the speech input timeout (YES at step ST18), the speech section detecting unit 107 sets the first speech section detection threshold stored at step ST13 as a threshold for decision (step ST19).

According to the first speech section detection threshold set at step ST19, the speech section detecting unit 107 decides whether it can detect the speech section or not from the speech data inputted via the speech input unit 105 after completing the speech section detection threshold learning at step ST16 (step ST20). Here, the speech section detecting unit 107 stores the speech data inputted after the learning processing at step ST16 in the storage area (not shown), and detects the initial position and the final position of the speech production by employing the first speech section detection threshold set newly at step ST19 with regard to the speech data stored.

In the example of FIG. 2, even if the noise G occurs, the initial position F₁ of the speech production F is higher than the value H which is the first speech section detection threshold, and the final position F₂ of the speech production F is lower than the value H which is the first speech section detection threshold. Thus, the speech section detecting unit 107 decides that it can detect the speech section (YES at step ST20).

If it can detect the speech section (YES at step ST20), the speech section detecting unit 107 proceeds to the processing at step ST21. On the other hand, if the speech section detecting unit 107 cannot detect the speech section even though it applies the first speech section detection threshold (NO at step ST20), it proceeds to the processing at step ST22 without carrying the speech recognition, and returns to the processing at step ST1.

While the speech recognition processing is executed in the processing from step ST17 to step ST22, only the speech section detection processing is performed (see the region L (speech section detection processing) and the region M (speech recognition processing) from the time D₁ to time E₁ of FIG. 2C).

As described above, according to the present embodiment 1, it is configured in such a manner that it comprises the non-speech section deciding unit 104 to detect a non-speech operation in a touch operation, and to decide whether a user is talking or not by the image recognition processing performed only during the non-speech operation; the speech section detection threshold learning unit 106 to learn the first speech section detection threshold of the speech data when the user is not talking; and the speech section detecting unit 107 to carry out the speech section detection again by using the first speech section detection threshold if it fails to detect the speech section detection by employing the second speech section detection threshold which is learned after detecting the operation for speech in the touch operation. Accordingly, even if the second speech section detection threshold set in the learning section during the operation for speech is an inappropriate value, the present embodiment 1 can detect an appropriate speech section using the first speech section detection threshold. In addition, it can control in such a manner as to prevent the image recognition processing and the speech recognition processing from being performed simultaneously. Accordingly, even if the speech recognition apparatus 100 is used for a tablet PC with a low processing performance, it can reduce the delay time until obtaining the speech recognition result, thereby being able to reduce the deterioration of the speech recognition performance.

In addition, the foregoing embodiment 1 presupposes the configuration in which the image recognition processing of the video data taken with a camera or the like only during the non-speech operation is carried out to make a decision as to whether the user is talking or not, but may be configured to make a decision as to whether or not the user is talking by using data acquired with a means other than the camera. For example, the present embodiment may be configured that when a tablet PC is equipped with a proximity sensor, the distance between the microphone of the tablet PC and the user's lips is calculated from the data acquired by the proximity sensor, and when the distance between the microphone and the lips is shorter than a preset threshold, it is decided that the user talks.

This enables the apparatus to prevent an increase of the processing load while the speech recognition processing is not performed, thereby being able to improve the speech recognition performance in the tablet PC with a low processing performance, and to enable the apparatus to execute processing other than the speech recognition.

Furthermore, using the proximity sensor makes it possible to reduce the power consumption as compared with the case of using the camera, thereby being able to improve the usefulness of the tablet PC with great restriction on the battery life.

### Embodiment 2

Although the foregoing embodiment 1 shows a configuration in which when it detects the non-speech operation, the lip image recognition unit 103 recognizes the lip images so as to decide whether a user is talking or not, the present embodiment 2 describes a configuration in which an operation for speech or non-speech operation is decided in accordance with the operation state of the user, and the speech input level is learnt during the non-speech operation.

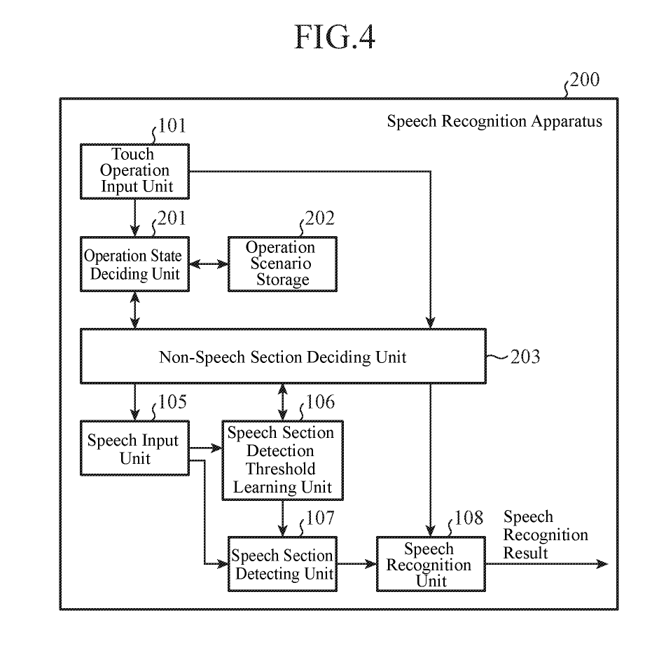

FIG. 4 is a block diagram showing a configuration of a speech recognition apparatus 200 of the embodiment 2.

The speech recognition apparatus 200 of the embodiment 2 comprises, instead of the image input unit 102, lip image recognition unit 103 and non-speech section deciding unit 104 of the speech recognition apparatus 100 shown in the embodiment 1, an operation state deciding unit (non-speech operation recognition unit) 201, an operation scenario storage 202 and a non-speech section deciding unit 203.

In the following, the same or like components to those of the speech recognition apparatus 100 of the embodiment 1 are designated by the same reference symbols as those of the embodiment 1, and the description of them will be omitted or simplified.

The operation state deciding unit 201 decides the operation state of a user by referring to the information about the touch operation of the user on the touch screen inputted from the touch operation input unit 101 and to the information indicating the operation state that makes a transition by a touch operation stored in the operation scenario storage 202. Here, the information about the touch operation refers to the coordinate values or the like at which the touch of the user onto the touch screen is detected.

The operation scenario storage 202 is a storage area for storing an operation state that makes a transition by the touch operation. For example, it is assumed that the following three screens are provided as the operation screen: an initial screen; an operation screen selecting screen that is placed on a lower layer of the initial screen for a user to choose an operation screen; and an operation screen on the screen chosen, which is placed on a lower layer of the operation screen selecting screen. When a user carries out a touch operation on the initial screen to cause the transition to the operation screen selecting screen, the information indicating that the operation state makes a transition from the initial state to the operation screen selecting state is stored as an operation scenario. In addition, when the user carries out a touch operation corresponding to a selecting button on the operation screen selecting screen to cause a transition to the operation screen of the selecting screen, the information indicating that the operation state makes a transition from the operation screen selecting state to a specific item input state on the screen chosen is stored as the operation scenario.

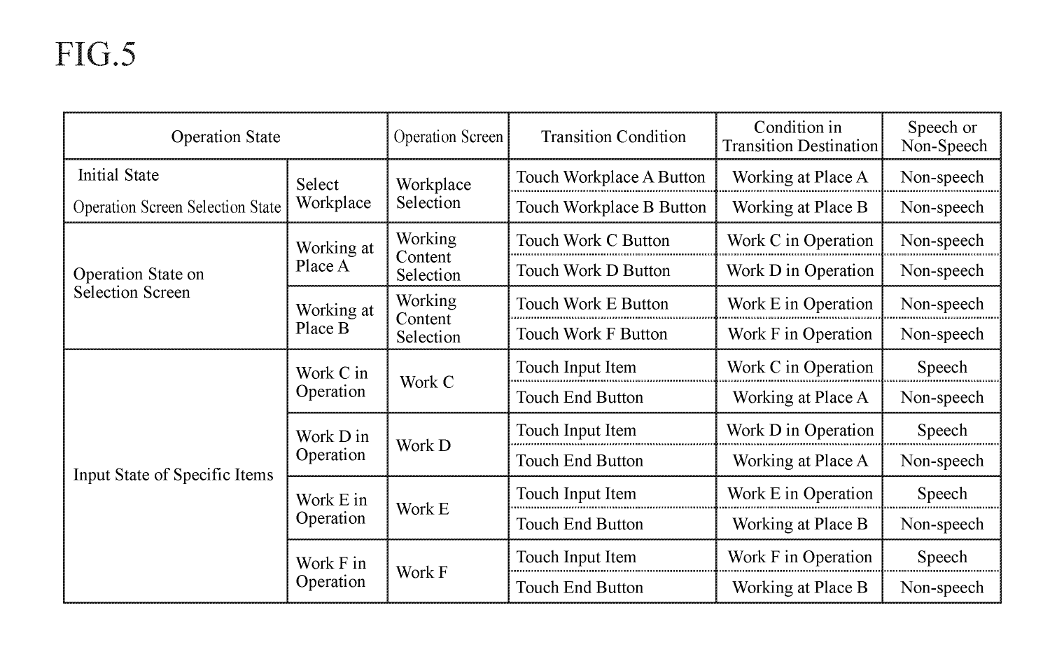

FIG. 5 is a table showing an example of the operation scenarios the operation scenario storage 202 of the speech recognition apparatus 200 of the embodiment 2 stores.

In the example of FIG. 5, an operation scenario consists of an operation state, a display screen, a transition condition, a state of a transition destination, and information indicating either an operation accompanying speech or a non-speech operation.

First, as for the operation state, as a concrete example, the foregoing “initial state” and “operation screen selecting state” is related to “select workplace”; and as a concrete example, “working at place A” and “working at place B” are related to the foregoing “operation state on the screen chosen”. Furthermore, as a concrete example, the foregoing “input state of specific item” is related to four operation states such as “work C in operation”.

For example, when the operation state is “select workplace”, the operation screen displays “select workplace”. On the operation screen on which “select workplace” is displayed, if the user carries out “touch workplace A button” which is the transition condition, the operation state makes a transition to “working at place A”. On the other hand, when the user carries out the transition condition “touch workplace B button”, the operation state makes a transition “working at place B”. The operations “touch workplace A button” and “touch workplace B button” indicate that they are a non-speech operation.

In addition, when the operation state is “work C in operation”, for example, the operation screen displays “work C”. On the operation screen which displays “work C”, when the user carries out a transition condition “touch end button”, it makes a transition to the operation state “working at place A”. The operation “touch end button” indicates that it is a non-speech operation.

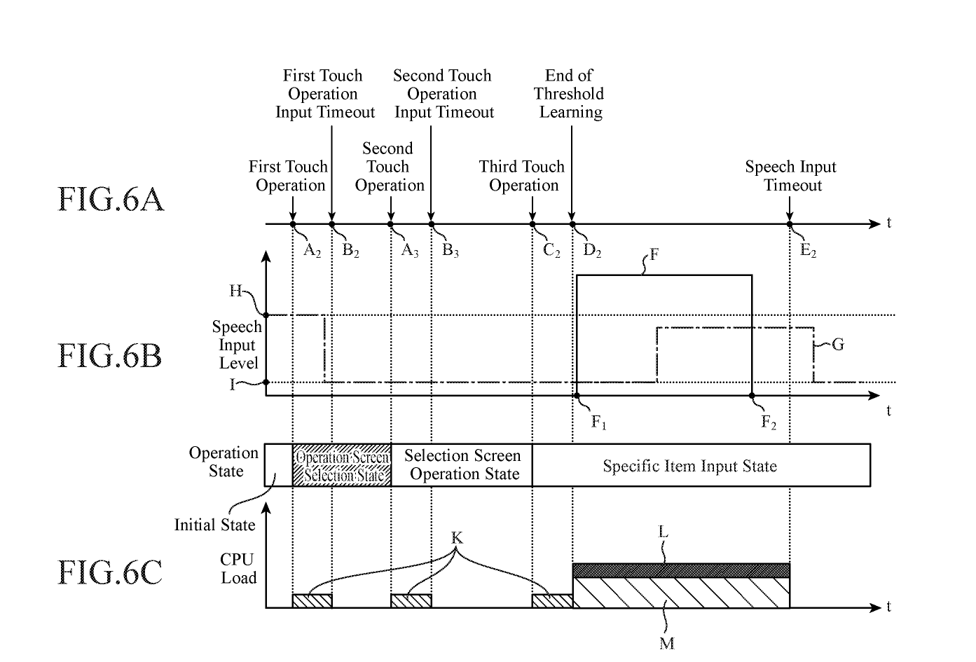

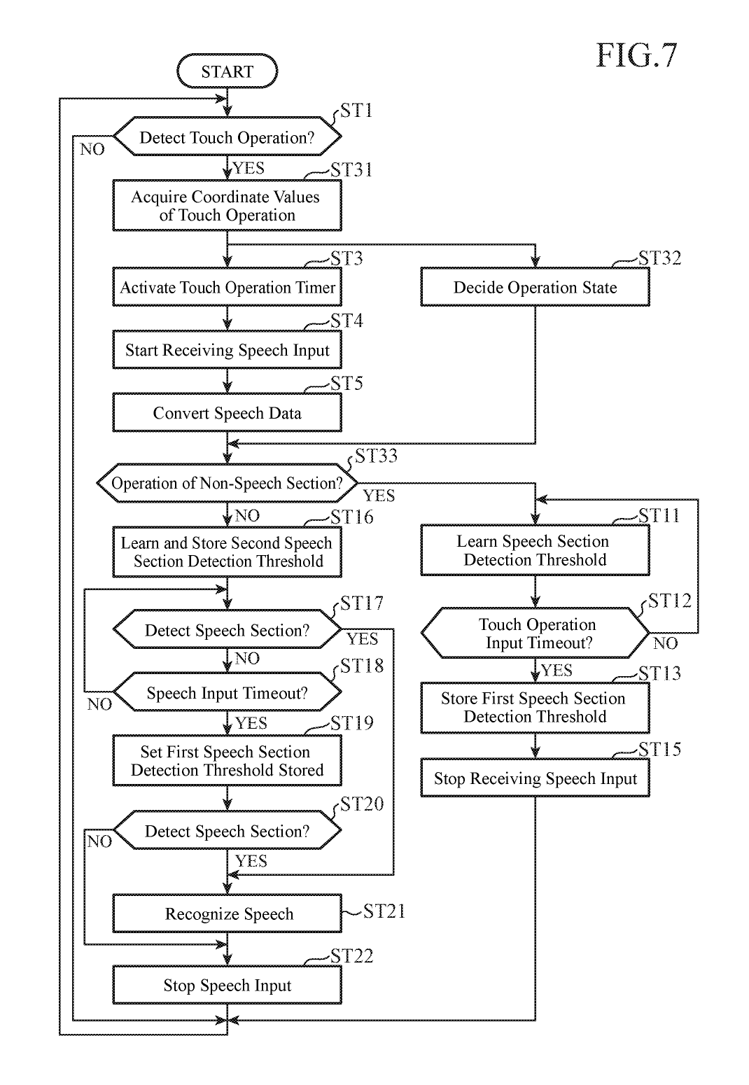

Next, referring to FIG. 6 and FIG. 7, the operation of the speech recognition apparatus 200 of the embodiment 2 will be described. FIG. 6 is a diagram illustrating an example of the input operation to the speech recognition apparatus 200 of the embodiment 2; and FIG. 7 is a flowchart showing the operation of the speech recognition apparatus 200 of the embodiment 2. Incidentally, in the following description, the same steps as those of the speech recognition apparatus 100 of the embodiment 1 are designated by the same reference symbols as those of FIG. 3, and the description of them will be omitted or simplified.

First, FIG. 6A shows on the time axis, time A₂ at which a user carries out a first touch operation, time B₂ indicating the input timeout of the first touch operation, time A₃ at which the user carries out a second touch operation, time B₃ indicating the input timeout of the second touch operation, time C₂ at which the user carries out a third touch operation, time D₂ indicating the end of the threshold learning, and time E₂ indicating the speech input timeout.

FIG. 6B shows a time variation of the input level of the speech supplied to the speech input unit 105. A solid line indicates speech production F (F₁ is the initial position of the speech production, and F₂ is the final position of the speech production), and a dash-dotted line shows noise G. The value H shown on the axis of the speech input level designates the first speech section detection threshold, and the value I designates the second speech section detection threshold.

FIG. 6C shows a time variation of the CPU load of the speech recognition apparatus 200. The region K designates a load of the threshold learning processing, the region L designates a load of the speech section detection processing, and the region M designates a load of the speech recognition processing.

When the user touches a part of the touch screen, the touch operation input unit 101 detects the touch operation (YES at step ST1), acquires the coordinate values at the part it detects the touch operation, and outputs the coordinate values to the non-speech section deciding unit 203 and the operation state deciding unit 201 (step ST31). Acquiring the coordinate values output at step ST31, the non-speech section deciding unit 203 activates the built-in timer and starts measuring a time elapsed from the detection of the touch operation (step ST3). Furthermore, the non-speech section deciding unit 203 instructs the speech input unit 105 to start the speech input. In response to the instruction, the speech input unit 105 starts the input reception of the speech (step ST4) and converts the acquired speech to the speech data (step ST5).

On the other hand, acquiring the coordinate values outputted at step ST31, the operation state deciding unit 201 decides the operation state of the operation screen by referring to the operation scenario storage 202 (step ST32). The decision result is outputted to the non-speech section deciding unit 203. The non-speech section deciding unit 203 makes a decision as to whether or not the touch operation is a non-speech operation without accompanying an utterance by referring to the coordinate values outputted at step ST31 and the operation state output at step ST32 (step ST33). If the touch operation is a non-speech operation (YES at step ST33), the non-speech section deciding unit 203 instructs the speech section detection threshold learning unit 106 to learn the threshold of the speech section detection. In response to the instruction, the speech section detection threshold learning unit 106 records a value of the highest speech input level within a prescribed period of time from the speech data inputted from the speech input unit 105, for example (step ST11). After that, the processing at steps ST12, ST13 and ST15 is executed, followed by returning to the processing at step ST1.

Two examples in which a decision of the non-speech operation is made at step ST33 (YES at step ST33) will be described below. First, an example will be described in which the operation state makes a transition from the “initial state” to the “operation screen selecting state”. In the case where the first touch operation indicated by the time A₂ of FIG. 6A is inputted, the first touch operation of the user is carried out on the initial screen, and if the coordinate values inputted by the first touch operation are within a region in which a transition to a specific operation screen is selected (for example, a button for proceeding to the operation screen selection), the operation state deciding unit 201 acquires the transition information indicating that the operation state makes a transition from the “initial state” to the “operation screen selecting state” by referring to the operation scenario storage 202 as the decision result at step ST32.

Referring to the operation state acquired at step ST32, the non-speech section deciding unit 203 decides that the touch operation in the “initial state” is a non-speech operation which does not necessitate any utterance for making a transition of the screen (YES at step ST33). When it is decided that the touch operation is the non-speech operation, only the speech section threshold learning processing is performed up to the time B₂ of the first touch operation input timeout (see the region K (speech section detection threshold learning processing) from the time A₂ to the time B₂ of FIG. 6C).

Next, an example will be described which shows a transition from the “operation screen selecting state” to the “operation state on the selecting screen”. In the case where the second touch operation indicated by the time B₂ of FIG. 6A is inputted, the second touch operation of the user is carried out on the operation screen selecting screen, and if the coordinate values inputted by the second touch operation are within the region in which a transition to a specific operation screen is selected (for example, a button for selecting the operation screen,), the operation state deciding unit 201 refers to the operation scenario storage 202 at step ST32 and acquires the transition information indicating the transition of the operation state from the “operation screen selecting state” to the “operation state on the selecting screen” as a decision result.

Referring to the operation state acquired at step ST32, the non-speech section deciding unit 203 decides that the touch operation in the “operation screen selecting state” is a non-speech operation (YES at step ST33). If it is decided that the touch operation is the non-speech operation, only the speech section threshold learning processing is performed up to the time B₃ of the second touch operation input timeout (see the region K (speech section detection threshold learning processing) from the time A₃ to the time B₃ of FIG. 6C).

On the other hand, if the touch operation is an operation for speech (NO at step ST33), the non-speech section deciding unit 203 instructs the speech section detection threshold learning unit 106 to learn the threshold of the speech section detection. In response to the instruction, the speech section detection threshold learning unit 106 learns, for example, a value of the highest speech input level within a prescribed period of time from the speech data inputted from the speech input unit 105, and stores the value as the second speech section detection threshold (step ST16). After that, it executes the same processing as the processing from step ST17 to step ST22.

An example in which it is decided that the touch operation is the operation for speech at step ST33 (NO at step ST33) will be described below.

An example showing a transition from the “operation state on the selecting screen” to the “input state of a specific item” will be described. In the case where a third touch operation indicated in the time C₂ of FIG. 6A is inputted, the third touch operation of the user is carried out on the operation screen of the selecting screen, and if the coordinate values inputted by the third touch operation are within a region in which a transition to the specific operation item is selected (for example, a button for selecting an item), the operation state deciding unit 201 refers to the operation scenario storage 202 at step ST32, and acquires the transition information indicating the transition of the operation state from the “operation state on the operation screen” to the “input state of a specific item” as a decision result.

If the operation state obtained at step ST32 shows that the touch operation is of “operation state on the selecting screen” and if the coordinate values outputted at step ST31 are within an input region of a specific item accompanying a speech utterance, the non-speech section deciding unit 203 decides that the touch operation is the operation for speech (NO at step ST33). If it is decided that the touch operation is the operation for speech, the speech section threshold learning processing operates up to the time D₂ at which the threshold learning is completed, and furthermore, the speech section detection processing and the speech recognition processing operate up to the time E₂ of the speech input timeout (see, the region K (speech section detection threshold learning processing) from the time C₂ to the time D₂ in FIG. 6C, and the region L (speech section detection processing) and the region M (speech recognition processing) from the time D₂ to the time E₂).

As described above, according to the present embodiment 2, it is configured in such a manner as to comprise the operation state deciding unit 201 to decide the operation state of the user from the operation states which are stored in the operation scenario storage 202 and make a transition according to the touch operation, and from the information about the touch operation inputted from the touch operation input unit 101; and the non-speech section deciding unit 203 to instruct, when it is decided that the touch operation is the operation for speech, the speech section detection threshold learning unit 106 to learn the first speech section detection threshold. Accordingly, the present embodiment 2 can obviate the necessity for the capturing means like a camera for detecting the non-speech operation and does not require the image recognition processing with a large amount of computation. Accordingly, it can prevent the degradation of the speech recognition performance even when the speech recognition apparatus 200 is employed for a tablet PC with a low processing performance.

In addition, it is configured in such a manner that even if the failure occurs in detecting the speech section by using the second speech section detection threshold learned after detecting the operation for speech, the speech section detection is executed again by using the first speech section detection threshold learned during the non-speech operation. Accordingly, the appropriate speech section can be detected even if an appropriate threshold cannot be set during the operation for speech.

In addition, since the present embodiment does not require the input means like a camera for detecting the non-speech operation, the present embodiment can reduce the power consumption of the input means. Thus, the present embodiment can improve the convenience when employed for a tablet PC or the like with a great restriction on the battery life.

### Embodiment 3

A speech recognition apparatus can be configured by combining the foregoing embodiments 1 and 2.

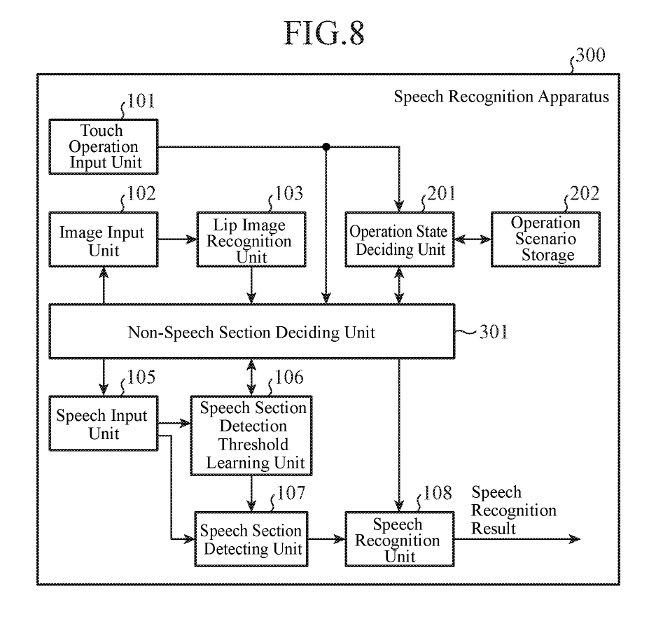

FIG. 8 is a block diagram showing a configuration of a speech recognition apparatus 300 of an embodiment 3. The speech recognition apparatus 300 is configured by adding the image input unit 102 and the lip image recognition unit 103 to the speech recognition apparatus 200 of the embodiment 2 shown in FIG. 4, and by replacing the non-speech section deciding unit 203 by a non-speech section deciding unit 301.

When the non-speech section deciding unit 301 decides that a touch operation is a non-speech operation without accompanying an utterance, the image input unit 102 acquires videos taken with a capturing means like a camera and converts the videos to the image data, and the lip image recognition unit 103 carries out analysis of the image data acquired, and recognizes the movement of the user's lips. If the lip image recognition unit 103 decides that the user is not talking, the non-speech section deciding unit 301 instructs the speech section detection threshold learning unit 106 to learn a speech section detection threshold.

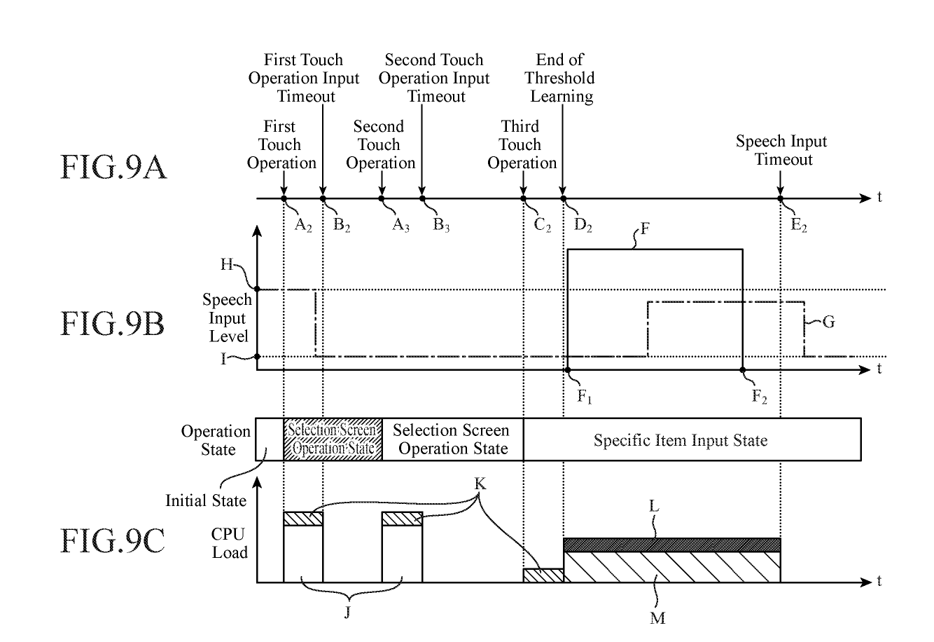

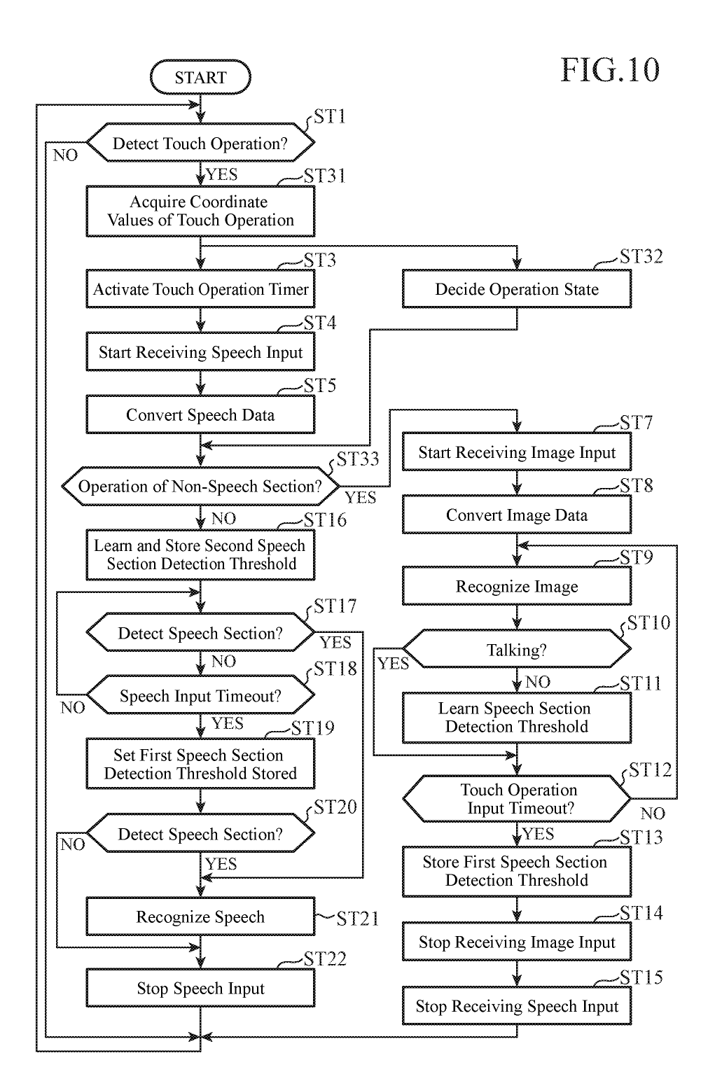

Next, referring to FIG. 9 and FIG. 10, the operation of the speech recognition apparatus 300 of the embodiment 3 will be described. FIG. 9 is a diagram illustrating an example of the input operation of the speech recognition apparatus 300 of the embodiment 3; and FIG. 10 is a flowchart showing the operation of the speech recognition apparatus 300 of the embodiment 3. Incidentally, in the following, the same steps as those of the speech recognition apparatus 200 of the embodiment 2 are designated by the same reference symbols as those used in FIG. 7, and the description of them is omitted or simplified.

First, the arrangement from FIG. 9A to FIG. 9C is the same as the arrangement shown in FIG. 6 of the embodiment 2 except that the region J indicating the image recognition processing in FIG. 9C is added.

Since the operation up to step ST33, at which the non-speech section deciding unit 301 makes a decision as to whether or not the touch operation is a non-speech operation without accompanying an utterance from the coordinate values outputted from the touch operation input unit 101 and from the operation state output from the operation state deciding unit 201, is the same as that of the embodiment 2, the description thereof is omitted. If the touch operation is a non-speech operation (YES at step ST33), the non-speech section deciding unit 301 carries out the processing from step ST7 to step ST15 shown in FIG. 3 of the embodiment 1, followed by returning to the processing at step ST1. More specifically, in addition to the processing of the embodiment 2, the speech recognition apparatus 300 carries out the image recognition processing of the image input unit 102 and lip image recognition unit 103. On the other hand, if the touch operation is an operation for speech (NO at step ST33), the speech recognition apparatus 300 carries out the processing from step ST16 to step ST22, followed by returning to the processing at step ST1.

An example in which the non-speech section deciding unit 301 decides that the touch operation is a non-speech operation at step ST33 (YES at step ST33) is the first touch operation and second touch operation in FIG. 9. On the other hand, an example in which it decides at step ST33 that the touch operation is an operation for speech (NO at step ST33) is the third touch operation in FIG. 9. Incidentally, in FIG. 9C, in addition to the speech section detection threshold learning processing (see, the region K) in the first touch operation and second touch operation, the image recognition processing (see, the region J) is carried out further. Since the other processing is the same as that of FIG. 6 shown in the embodiment 2, the detailed description thereof will be omitted.

As described above, according to the present embodiment 3, it is configured in such a manner as to comprise the operation state deciding unit 201 to decide the operation state of a user from the operation states that are stored in the operation scenario storage 202 and make a transition in response to the touch operation and from the information about the touch operation inputted from the touch operation input unit 101; and the non-speech section deciding unit 301 to instruct the lip image recognition unit 103 to perform the image recognition processing only when a decision of the non-speech operation is made, and to instruct the speech section detection threshold learning unit 106 to learn the first speech section detection threshold only when the decision of the non-speech operation is made. Accordingly, the present embodiment 3 can carry out the control in such a manner as to prevent the image recognition processing and the speech recognition processing, which have a great processing load, from being performed simultaneously, and can limit the occasion of carrying out the image recognition processing in accordance with the operation scenario. In addition, it can positively learn the first speech section detection threshold while a user is not talking. For these reasons, the speech recognition apparatus 300 can improve the speech recognition performance when employed for a tablet PC with a low processing performance.

In addition, since the present embodiment 3 is configured in such a manner that if the failure occurs in detecting the speech section using the second speech section detection threshold learned after the detection of the operation for speech, the speech section detection is carried out again using the first speech section detection threshold learned during the non-speech operation. Accordingly, it can detect the appropriate speech section even if it cannot set an appropriate threshold during the operation for speech.

In addition, the foregoing embodiment 3 has the configuration in which a decision as to whether or not a user is talking is made through the image recognition processing of the videos taken with the camera only during the non-speech operation, but may be configured to decide whether or not the user is talking, using the data acquired by a means other than the camera. For example, the present embodiment may be configured that when a tablet PC has a proximity sensor, the distance between the microphone of the tablet PC and the user's lips is calculated from the data the proximity sensor acquires, and if the distance between the microphone and the lips becomes shorter than a preset threshold, it is decided that the user gives utterance.

This makes it possible to suppress an increase in the processing load of the apparatus while the speech recognition processing is not performed, thereby being able to improve the speech recognition performance of the tablet PC with a low processing performance, and to carry out the processing other than the speech recognition.

Furthermore, using the proximity sensor enables reducing the power consumption as compared with the case of using the camera, thereby being able to improve the operability in a tablet PC with great restriction on the battery life.

Incidentally, the foregoing embodiments 1 to 3 show an example having only one threshold of the speech input level which the speech section detection threshold learning unit 106 sets, but may be configured that the speech section detection threshold learning unit 106 learns the speech input level threshold every time the speech section detection threshold learning unit 106 detects the non-speech operation, and that the speech section detection threshold learning unit 106 sets a plurality of thresholds it learns.

It may be configured that when the plurality of thresholds are set, the speech section detecting unit 107 carries out the speech section detection processing at step ST19 and step ST20 shown in the flowchart of FIG. 3 multiple times using the plurality of thresholds set, and only when the speech section detecting unit 107 detects the initial position and the final position of a speech production section, the speech section detecting unit 107 outputs a result as the speech section it detects.

Thus, only the speech section detection processing can be executed multiple times, thereby making is possible to prevent an increase of the processing load, and to improve the speech recognition performance even when the speech recognition apparatus is employed for a tablet PC with a low processing performance.

In addition, the foregoing embodiments 1 to 3 show the configuration in which when the speech section is not detected in the decision processing at step ST20 shown in the flowchart of FIG. 3, the input of speech is stopped without carrying out the speech recognition, but may be configured to carry out the speech recognition and output the recognition result even if the speech section is not detected.

For example, the present embodiments may be configured that when the speech input timeout occurs in a state where the initial position of the speech production is detected but the final position thereof is not detected, the speech section from the initial position of the speech production detected to the speech input timeout is detected as the speech section, and the speech recognition is carried out, and the recognition result is outputted. This enables a user to easily grasp the behavior of the speech recognition apparatus because a speech recognition result is always output when the user carries out an operation for speech, thereby being able to improve the operability of the speech recognition apparatus.

In addition, the foregoing embodiments 1 to 3 are configured in such a manner that when failure occurs in detecting the speech section (for example, when the timeout occurs) by using the second speech section detection threshold learned after detecting the operation for speech in the touch operation, the speech section detection processing is carried out again by using the first speech section detection threshold learned during the non-speech operation by the touch operation and the speech recognition result is outputted, but may be configured that even when the failure occurs in detecting the speech section, the speech recognition is carried out, and the recognition result is outputted, and the speech recognition result obtained is represented as a correction candidate by carrying out the speech section detection by using the first speech section detection threshold learned during the non-speech operation. This makes it possible to shorten a response time until the first output of the speech recognition result, thereby being able to improve the operability of the speech recognition apparatus.

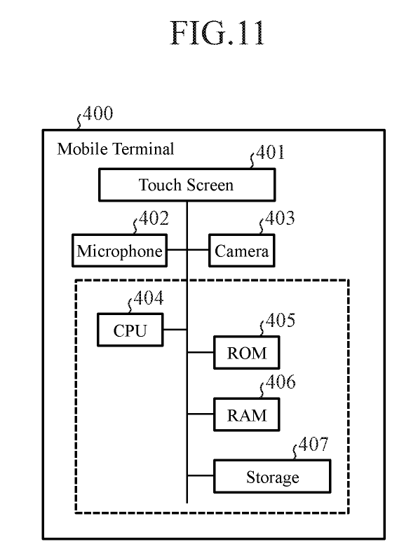

The speech recognition apparatus 100, 200 or 300 shown in any of the foregoing embodiments 1 to 3 is mounted on a mobile terminal 400 like a tablet PC with a hardware configuration as shown in FIG. 11, for example. The mobile terminal 400 of FIG. 11 is comprised of a touch screen 401, a microphone 402, a camera 403, a CPU 404, a ROM (Read Only Memory) 405, a RAM (Random Access Memory) 406 and a storage 407. Here, the hardware that implements the speech recognition apparatus 100, 200 or 300 includes the CPU 404, ROM 405, RAM 406 and storage 407 shown in FIG. 11.

As for the touch operation input unit 101, image input unit 102, lip image recognition unit 103, non-speech section deciding units 104, 203 or 301, speech input unit 105, threshold learning unit 106, speech section detecting unit 107, speech recognition unit 108 and operation state deciding unit 201, they are realized by the CPU 404 that executes programs stored in the ROM 405, RAM 406 and storage 407. In addition, a plurality of processors can execute the foregoing functions in cooperation with each other.

Incidentally, it is to be understood that a free combination of the individual embodiments, variations of any components of the individual embodiments or removal of any components of the individual embodiments is possible within the scope of the present invention.

### INDUSTRIAL APPLICABILITY

A speech recognition apparatus in accordance with the present invention can suppress a processing load. Accordingly, it is suitable for an application to such a device as a tablet PC and a smartphone without having a high processing performance, to carry out quick output of a speech recognition result and high performance speech recognition.

### REFERENCE SIGNS LIST

100, 200, 300 speech recognition apparatus; 101 touch operation input unit; 102 image input unit; 103 lip image recognition unit; 104, 203, 301 non-speech section deciding unit; 105 speech input unit; 106 speech section detection threshold learning unit; 107 speech section detecting unit; 108 speech recognition unit; 201 operation state deciding unit; 202 operation scenario storage; 400 mobile terminal; 401 touch screen; 402 microphone; 403 camera; 404 CPU; 405 ROM; 406 RAM; 407 storage.

1-6. (canceled)

7. A speech recognition apparatus comprising:
a speech input unit to acquire collected speech and to convert the speech to speech data;
a non-speech information input unit to acquire information other than the speech;
a non-speech operation recognition unit to recognize a user state from the information other than the speech the non-speech information input unit acquires;
a non-speech section decider to decide whether the user is talking or not from the user state the non-speech operation recognition unit recognizes;
a threshold learning unit to set a first threshold from the speech data converted by the speech input unit when the non-speech section decider decides that the user is not talking, and to set a second threshold from the speech data converted by the speech input unit when the non-speech section decider decides that the user is talking;
a speech section detector to detect, using the threshold set by the threshold learning unit, a speech section indicating that the user is talking from the speech data converted by the speech input unit; and
a speech recognition unit to recognize the speech data in the speech section detected by the speech section detector, and to output a recognition result, wherein
the speech section detector detects the speech section by using the first threshold, if the speech section detector cannot detect the speech section by using the second threshold.

8. The speech recognition apparatus according to claim 7, wherein
the non-speech information input unit acquires information about a position at which the user performs a touch input operation and acquires image data in which the user state is imaged, and
the non-speech operation recognition unit recognizes movement of the user's lips from the image data acquired by the non-speech information input unit, and
the non-speech section decider decides whether the user is talking or not from the information about the position acquired by the non-speech information input unit acquires and from the information indicating the movement of the lips the non-speech operation recognition unit recognizes.

9. The speech recognition apparatus according to claim 7, wherein
the non-speech information input unit acquires information about a position at which the user performs a touch input operation, and
the non-speech operation recognition unit recognizes an operation state of operation input of the user from the information about the position the non-speech information input unit acquires and from transition information indicating the operation state of the user, which makes a transition in response to the touch input operation, and
the non-speech section decider decides whether the user is talking or not from the operation state the non-speech operation recognition unit recognizes and from the information about the position the non-speech information input unit acquires.

10. The speech recognition apparatus according to claim 7, wherein
the non-speech information input unit acquires information about a position at which the user performs a touch input operation and acquires image data in which the user state is imaged, and
the non-speech operation recognition unit recognizes an operation state of operation input of the user from the information about the position the non-speech information input unit acquires and from transition information indicating the operation state of the user, which makes a transition in response to the touch input operation, and recognizes movement of the user's lips from the image data the non-speech information input unit acquires, and
the non-speech section decider decides whether the user is talking or not from the operation state the non-speech operation recognition unit recognizes, the information indicating the movement of the lips, and the information about the position the non-speech information input unit acquires.

11. The speech recognition apparatus according to claim 7, wherein
the speech section detector counts time upon detection of a start point of the speech section, detects, in a case in which the speech section detector cannot detect an end point of the speech section even if the count value reaches a designated timeout point, an interval from the start point of the speech section to the timeout point, as the speech section using the second threshold, and detects the interval from the start point of the speech section to the timeout point, as the speech section of a correction candidate by using the first threshold, and
the speech recognition unit recognizes the speech data in the speech section detected by the speech section detector and outputs a recognition result, and recognizes the speech data in the speech section of the correction candidate and outputs a recognition result correction candidate.

12. A speech recognition method comprising:
acquiring, by a speech input unit, collected speech and converting the speech to speech data;
acquiring, by a non-speech information input unit, information other than the speech;
recognizing, by a non-speech operation recognition unit, a user state from the information other than the speech;
deciding, by a non-speech section decider, whether the user is talking or not from the user state recognized:
setting, by a threshold learning unit, a first threshold from the speech data when decided that the user is not talking, and a second threshold when decided that the user is talking;
detecting, by a speech section detector, a speech section indicating that the user is talking from the speech data converted by the speech input unit by using the first threshold or the second, and detecting the speech section by using the first threshold when the speech section cannot be detected by using the second threshold; and
recognizing, by a speech recognition unit, speech data in the speech section detected, and outputting a recognition result.
